(19) United States
(12) Patent Application Publication
(10) Pub. No.: US 2016/0045822 A1
(43) Pub. Date: Feb. 18, 2016

(54) JOYSTICK CONTROLLING SYSTEM

(71) Applicant: Ren-Yang PAN, Taipei City (TW)

(72) Inventor: Ren-Yang PAN, Taipei City (TW)

(21) Appl. No.: 14/820,816

(22) Filed: Aug. 7, 2015

(30) Foreign Application Priority Data
Aug. 13, 2014 (TW) 103127737

(51) Int. Cl. A63F 13/24; A63F 13/235; H04W 4/00; A63F 13/211

(52) U.S. Cl. CPC A63F 13/24; A63F 13/211; A63F 13/235; H04W 4/008

(57) ABSTRACT

A joystick controlling system comprises: a joystick input device and an output processing device, and the joystick input device wirelessly transmits a manipulated motion of the joystick input device as motion status information, and the output processing device displays a linear graph corresponding to the motion status information on a displaying module of the output processing device according to the motion status information.

### CROSS-REFERENCE TO RELATED APPLICATION

This application claims priority to Taiwanese Patent Application No. 103127737, filed Aug. 13, 2014, which is hereby incorporated by reference.

### FIELD OF THE INVENTION

The present invention relates to a joystick, and more particularly to a joystick controlling system.

### BACKGROUND OF THE INVENTION

A joystick is a kind of input equipment generally consisting of a base and a control stick that pivots on the base. The applying field of joysticks is very wide. For example, a joystick can be used as a flight controller of an aircraft, and can be used to control a hoist or a robot. Presently, joysticks are mostly applied to the operations of objects or characters in video game.

In the general usage of joysticks, the base of a joystick has to be set up on a fixture such as a desktop or a machine for the user to easily control the control stick and to thus able to enter information. Besides, the content of the information inputted by the joystick is mainly determined by the pivoting direction of the control stick. Therefore, a joystick can only perform input of four or eight directions and thus results in low sensitivity of the joystick inputs. For this reason, it is difficult to apply the conventional joysticks to the hand writing input, hand gesture input, and pen gesture input that are frequently used in currently popular smart devices. Thus, the conventional joysticks encounter the challenge of being ruled out of the market gradually.

### SUMMARY OF THE INVENTION

Since the conventional joysticks have to be set up on a fixture for ease of use, and the manipulation of the conventional joysticks is limited, it is hard to apply a precise and deft operation in a conventional joystick.

Therefore, one of the purposes of the present invention is to provide a joystick controlling system that can perform precise and deft joystick operations.

The technical means used by the present invention to overcome the drawbacks in prior art is to provide a joystick controlling system, comprising:

a joystick input device including a movable carrier, a gyroscope module, an accelerometer module, an information generating module and a wireless transmitting module, wherein the gyroscope module, the accelerometer module, the information generating module and the wireless transmitting module are disposed on the movable carrier, and the information generating module is electrically connected with the gyroscope module and the accelerometer module, and the information generating module generates a motion status information according to a manipulated motion of the movable carrier detected by the gyroscope module and the accelerometer module, and the wireless transmitting module is electrically connected with the information generating module so as to wirelessly transmit the motion status information which is from the information generating module; and

an output processing device which is wirelessly connected with the joystick input device, the output processing device including a wireless receiving module, an information processing module and a displaying module, wherein the wireless receiving module is configured to receive the motion status information, and the information processing module is electrically connected with the wireless receiving module and the displaying module so as to display a linear graph corresponding to the motion status information on the displaying module.

In one embodiment of the present invention, the joystick input device further includes an input interface module which is disposed on the surface of the movable carrier, and the input interface module is electrically connected with the information generating module.

In one embodiment of the present invention, the input interface module includes a push button component and a roller component.

In one embodiment of the present invention, the input interface module includes a microphone component.

In one embodiment of the present invention, the joystick input device further includes an awakening module which is electrically connected with the input interface module, the information generating module and/or the wireless transmitting module, in which the awakening module is configured to awake the information generating module and/or the wireless transmitting module after the input interface module is performed with a predetermined operation.

In one embodiment of the present invention, the joystick input device further includes a safety module which is connected with the information generating module and/or the wireless transmitting module in such a manner that the safety module is configured to stop the information generating module from generating the motion status information and/or the safety module is configured to stop the wireless transmitting module from transmitting the motion status information according to the on-off state of the safety module.

In one embodiment of the present invention, the wireless transmitting module is a Bluetooth transmitting module.

In one embodiment of the present invention, the information processing module further includes a linear graph recognizing module, which is configured to recognize the linear graph corresponding to the motion status information, and the information processing module outputs a control command according to the recognition result.

In one embodiment of the present invention, the joystick input device further includes a light pen module which is disposed on the surface of the movable carrier and is configured to emit an indicator light signal.

By way of the technical means used by the present invention, the joystick input device does not have to be set up on a fixture, and thus the users can manipulate the joystick and perform input at anywhere they like. Furthermore, the joystick controlling system of the present invention can achieve high sensitivity, which enables the joystick to swiftly and accurately output a linear graph corresponding to a joystick motion of any direction and any speed variation manipulated by a user. Therefore, the joystick controlling system of the present invention not only can apply to the hand writing input, hand gesture input, and pen gesture input, but also can apply to various kinds of input such as mapping and painting so as to provide the user with convenient and nimble operation experience.

### BRIEF DESCRIPTION OF THE DRAWINGS

FIG. 1 is a three-dimensional view illustrating a joystick controlling system according to an embodiment of the present invention.

FIG. 2 is a block diagram illustrating the joystick controlling system according to the embodiment of the present invention.

FIGS. 3a, 3b, and 3c are schematic views illustrating the joystick controlling system according to the embodiment of the present invention being used.

FIGS. 4a and 4b are schematic views illustrating the joystick controlling system according to the embodiment of the present invention being used.

### DETAILED DESCRIPTION OF THE PREFERRED EMBODIMENTS

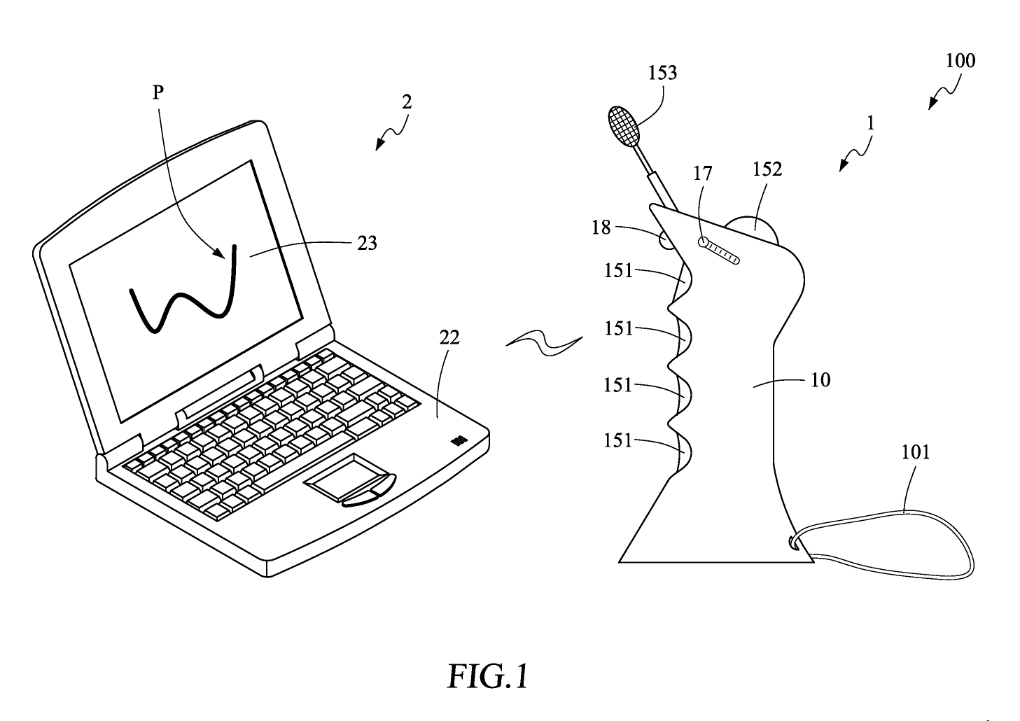

The implementation of the present invention is described as follows with reference to FIGS. 1 to 4b. The descriptions herein are not to be construed as limitations on the present invention, but to illustrate the embodiments of the present invention.

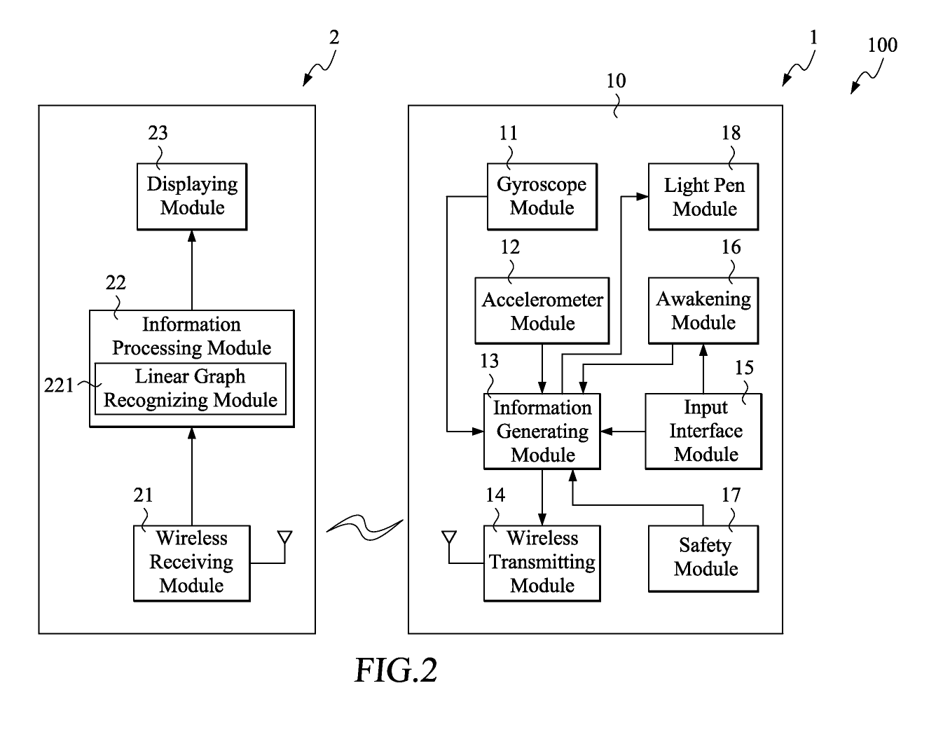

Please refer to FIGS. 1 and 2. According to one embodiment of the present invention, a joystick controlling system 100 comprises: a joystick input device 1 including a movable carrier 10, a gyroscope module 11, an accelerometer module 12, an information generating module 13 and a wireless transmitting module 14, wherein the gyroscope module 11, the accelerometer module 12, the information generating module 13 and the wireless transmitting module 14 are disposed on the movable carrier 10, and the information generating module 13 is electrically connected with the gyroscope module 11 and the accelerometer module 12, and the information generating module 13 generates a motion status information according to a manipulated motion of the movable carrier 10 detected by the gyroscope module 11 and the accelerometer module 12, and the wireless transmitting module 14 is electrically connected with the information generating module 13 so as to wirelessly transmit the motion status information which is from the information generating module 13; and an output processing device 2 which is wirelessly connected with the joystick input device 1, the output processing device 2 including a wireless receiving module 21, an information processing module 22 and a displaying module 23, wherein the wireless receiving module 21 is configured to receive the motion status information, and the information processing module 22 is electrically connected with the wireless receiving module 21 and the displaying module 23 so as to display a linear graph P corresponding to the motion status information on the displaying module 23.

In the present embodiment, the movable carrier 10 is roughly rod-shaped, and thus is suitable for single handhold. Preferably, the movable carrier 10 further includes a wrist strap 101 which can be worn on the wrist to prevent the falls of the movable carrier 10. The gyroscope module 11 is a module which serves gyroscope function and can thus measure and maintain orientation according to the conservation of angular momentum. The accelerometer module 12 is a module which serves accelerometer function and can thus measure acceleration, that is to say, the rate of change of velocity. With the gyroscope module 11 and the accelerometer module 12, the manipulated motion of any direction and any speed variation performed on the movable carrier 10 by the user can be detected. The manipulated motion specifically includes: up and down displacement motion, left and right displacement motion, forward and backward displacement motion, left and right tilt motion, forward and backward tilt motion, surface revolve motion, sway motion, locus motion and the combination of the above motions. The information generating module 13 generates a motion status information according to the detection result generated by the gyroscope module 11 and the accelerometer module 12. In the present embodiment, the wireless transmitting module 14 is a Bluetooth transmitting module. However, the present invention is not limited to this. The wireless transmitting module 14 can connect to the output processing device 2 via WIFI network or other wireless network.

Furthermore, in the present embodiment, the joystick input device 1 further includes an input interface module 15 which is disposed on the surface of the movable carrier 10, and the input interface module 15 is electrically connected with the information generating module 13 to provide input methods other than the manipulated motion, as shown in FIGS. 1 and 2. The input interface module 15 includes a plurality of push button components 151, a roller component 152, and a microphone component 153. Preferably, the plurality of push button components 151 and the roller component 152 are ergonomically disposed, wherein the push button components 151 are disposed at locations corresponding to the fingers of users taking hold of the movable carrier 10. The roller component 152 is disposed at a location corresponding to the thumb position of the user. The microphone component 153 is connected to the movable carrier 10 via an extendable rod on the microphone component 153 itself, providing the sound and voice input. Moreover, the input interface module 15 can include a charging interface (not shown in the drawings) for charging the joystick input device 1.

Please refer to FIGS. 1 and 2. The joystick input device 1 further includes an awakening module 16 which is electrically connected with the input interface module 15, the information generating module 13 and/or the wireless transmitting module 14. If the joystick input device 1 have not received any manipulation from the user after a predetermined period of time, the information generating module 13 will stop generating the motion status information and/or the wireless transmitting module 14 will stop transmitting the motion status information. The awakening module 16 is configured to awake the information generating module 13 and/or the wireless transmitting module 14 after a corresponding operation is performed on the input interface module 15, and then the information generating module 13 and/or the wireless transmitting module 14 resume normal operating status. The set up of the corresponding operation that triggers the awakening process performed by the awakening module 16 can be personalized. For example, the corresponding operation can be pressing a single designated push button component 151, or pressing a plurality of designated push button components 151 simultaneously.

Please refer to FIGS. 1 and 2. The joystick input device 1 further includes a safety module 17 which is connected with the information generating module 13 and/or the wireless transmitting module 14. In the present embodiment, the safety module 17 includes a push bar, and the position of the push bar determines the on-off state of the safety module 17. When the safety module 17 is in an “on” (turned-on) state, the information generating module 13 stops generating the motion status information correspondingly and/or the wireless transmitting module 14 stops transmitting the motion status information correspondingly. On the contrary, when the safety module 17 is in an “off” (turned-off) state, the information generating module 13 and/or the wireless transmitting module 14 resume normal operating status. By this method, the transmission of fallacious information can be prevented when the joystick input device 1 is moved accidentally or is carried by someone.

Please refer to FIGS. 1 and 2. The joystick input device 1 further includes a light pen module 18 which is disposed on the surface of the movable carrier 10 and is configured to emit an indicator light signal, for example, a laser beam. Preferably, the light pen module 18 can be configured to correspondingly point to the displaying module 23, and project the indicator light signal onto the displaying module 23 at which the indicator light signal forms a light point, which is taken as a reference by users to perform more accurate operations.

Please refer to FIGS. 1 and 2. The output processing device 2 can be applied to smart devices such as notebook computers, mobile phones, and tablet computers. The wireless receiving module 21 adopts a communication specification which corresponds to the wireless transmitting module 14 of the joystick input device 1 so as to receive the motion status information transmitted by the wireless transmitting module 14. The information processing module 22 analyzes the received motion status information and transforms it into a display signal and then transmits the display signal to the displaying module 23. The displaying module 23 can be an independent display device, a screen of a smart device, or a projector. The displaying module 23 displays under the control of the information processing module 22 the linear graph P which corresponds to the motion status information.

By the structure above, the joystick input device 1 in the joystick controlling system 100 of the present invention does not have to be set up on a fixture, and thus the users can manipulate the joystick and perform input at anywhere they like. Furthermore, the joystick controlling system 100 can achieve high sensitivity, which means the joystick can swiftly and accurately output a linear graph P corresponding to a joystick motion of any direction and any speed variation manipulated by a user.

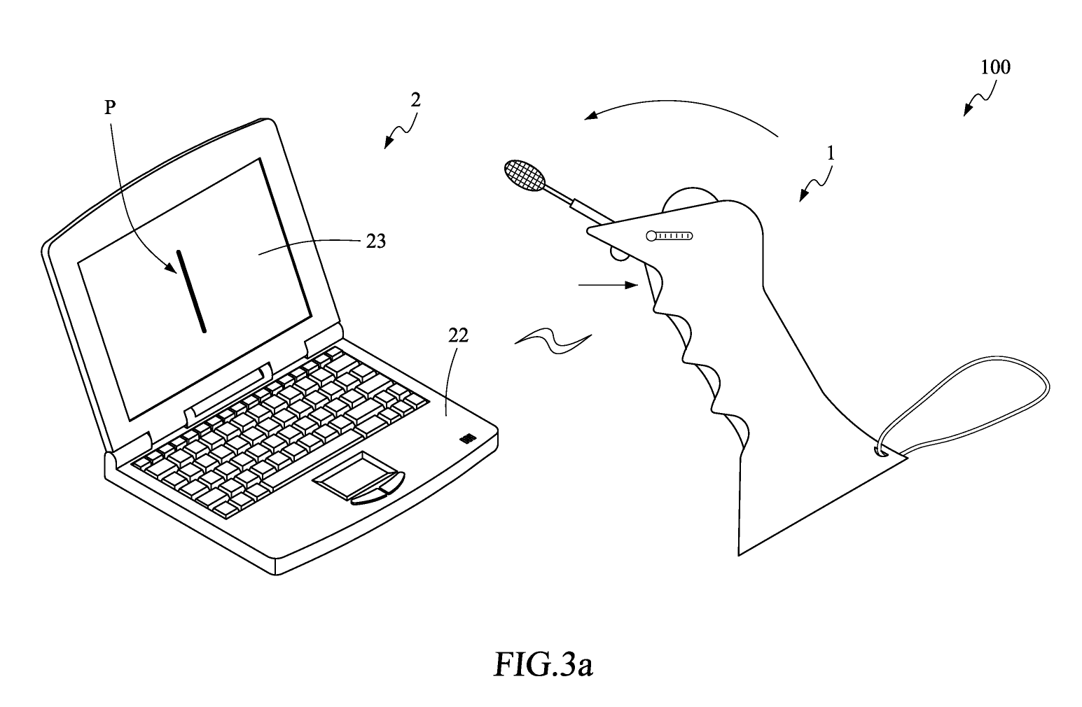

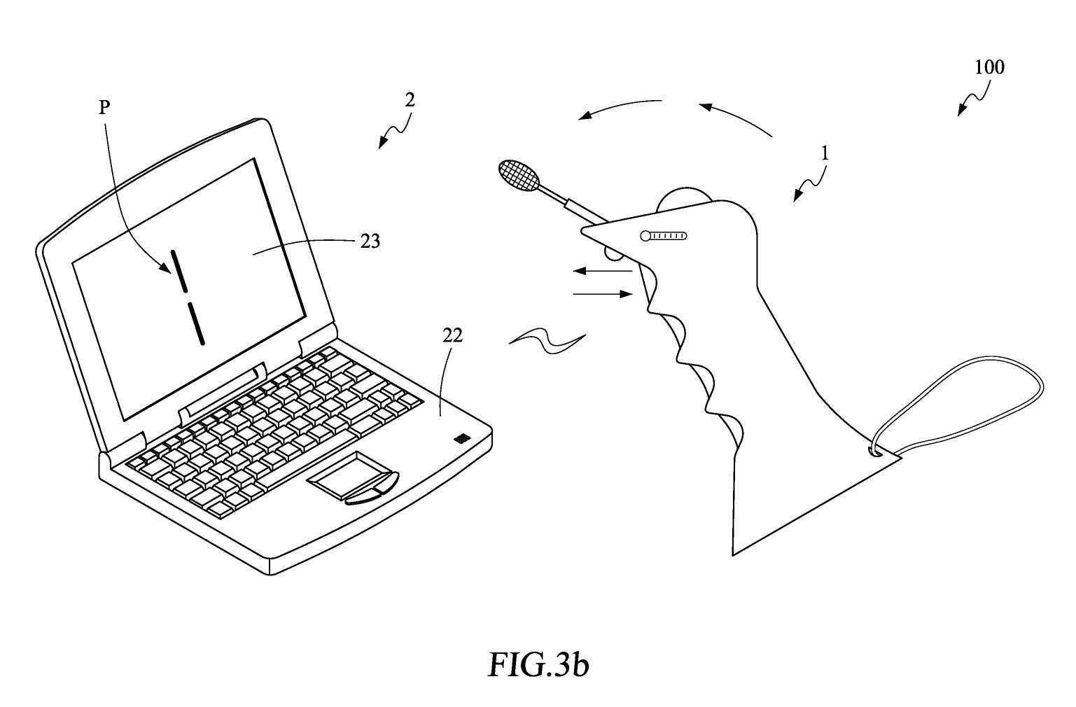

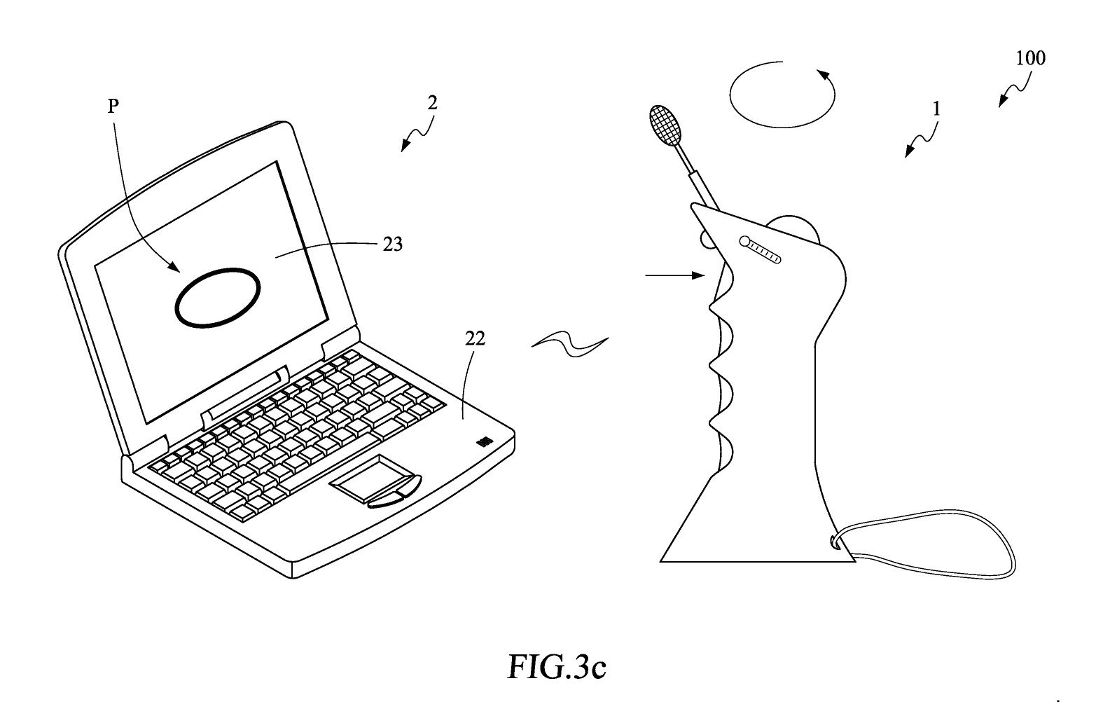

Specifically, as shown in FIGS. 3a to 3c, in an example of the joystick controlling system 100 being used according to the present embodiment, if a manipulating motion (forward tilt motion) is performed on the joystick input device 1, then the linear graph P shown on the displaying module 23 by the output processing device 2 is a vertical line (FIG. 3a). If a manipulating motion is performed on the joystick input device 1 and the input interface module 15 is operated accordingly. For example, perform forward tilt motion and press the push button component 151 simultaneously, release the push button component 151, and finally perform forward tilt motion and press the push button component 151 simultaneously again. The linear graph P shown on the displaying module 23 by the output processing device 2 includes two vertical lines and a blank area there between (FIG. 3b). If a manipulating motion (round locus motion) is performed on the joystick input device 1, then the linear graph P shown on the displaying module 23 by the output processing device 2 is a round line. Therefore, the joystick controlling system 100 of the present invention not only can apply to the hand writing input, hand gesture input, and pen gesture input, but also can apply to various kinds of input such as mapping and painting so as to provide the user with convenient and nimble operation experience.

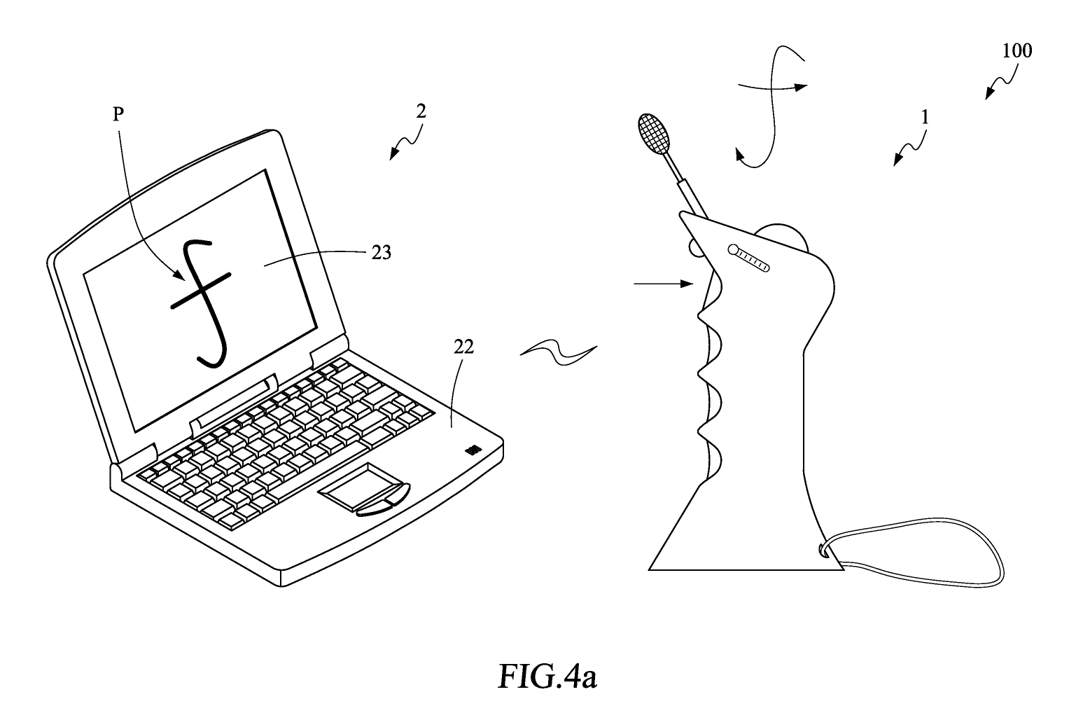

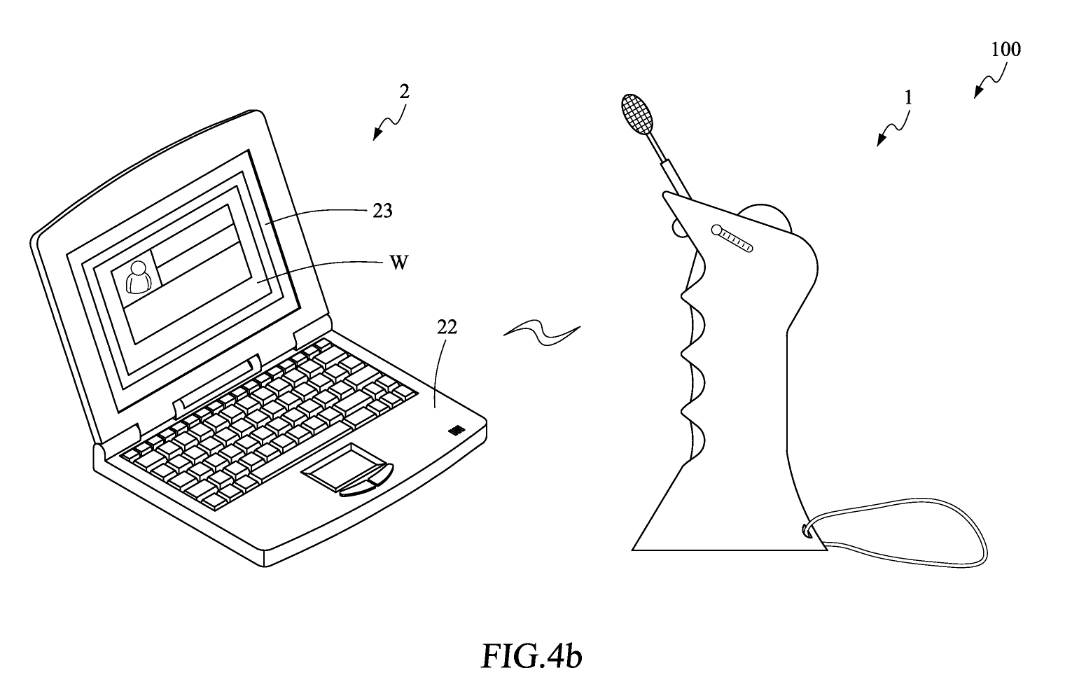

Furthermore, in the present embodiment, the information processing module 22 further includes a linear graph recognizing module 221, which is configured to recognize the linear graph P corresponding to the motion status information, and the information processing module 22 outputs a control command according to the recognition result, as shown in FIG. 2. Specifically, if a manipulating motion with an f-shaped track is performed on the joystick input device 1, then the linear graph P shown on the displaying module 23 by the output processing device 2 is an f-shape, as shown in FIGS. 4a and 4b. Furthermore, when the linear graph recognizing module 221 recognizes the “f” character line which matches the matching information configured in the linear graph recognizing module 221, the output processing device 2 outputs a corresponding control command. The control command can be used to direct system to execute actuations such as opening a webpage W, adjusting screen brightness, and adjusting volume.

The above description is only the description of the preferred embodiments of the present invention. However, a person with ordinary skill in the art may make various modifications to the present invention. Those modifications shall still fall within the spirit and the scope defined by the appended claims.

What is claimed is:

1. A joystick controlling system, comprising:
a joystick input device including a movable carrier, a gyroscope module, an accelerometer module, an information generating module and a wireless transmitting module, wherein the gyroscope module, the accelerometer module, the information generating module and the wireless transmitting module are disposed on the movable carrier, and the information generating module is electrically connected with the gyroscope module and the accelerometer module, and the information generating module generates a motion status information according to a manipulated motion of the movable carrier detected by the gyroscope module and the accelerometer module, and the wireless transmitting module is electrically connected with the information generating module so as to wirelessly transmit the motion status information which is from the information generating module; and
an output processing device which is wirelessly connected with the joystick input device, the output processing device including a wireless receiving module, an information processing module and a displaying module, wherein the wireless receiving module is configured to receive the motion status information, and the information processing module is electrically connected with the wireless receiving module and the displaying module so as to display a linear graph corresponding to the motion status information on the displaying module.

2. The joystick controlling system as claimed in claim 1, wherein the joystick input device further includes an input interface module which is disposed on the surface of the movable carrier, and the input interface module is electrically connected with the information generating module.

3. The joystick controlling system as claimed in claim 2, wherein the input interface module includes a push button component and a roller component.

4. The joystick controlling system as claimed in claim 2, wherein the input interface module includes a microphone component.

5. The joystick controlling system as claimed in claim 2, wherein the joystick input device further includes an awakening module which is electrically connected with the input interface module, the information generating module and/or the wireless transmitting module, in which the awakening module is configured to awake the information generating module and/or the wireless transmitting module after the input interface module is performed with a predetermined operation.

6. The joystick controlling system as claimed in claim 1, wherein the joystick input device further includes a safety module which is connected with the information generating module and/or the wireless transmitting module in such a manner that the safety module is configured to stop the information generating module from generating the motion status information and/or the safety module is configured to stop the wireless transmitting module from transmitting the motion status information according to the on-off state of the safety module.

7. The joystick controlling system as claimed in claim 1, wherein the wireless transmitting module is a Bluetooth transmitting module.

8. The joystick controlling system as claimed in claim 1, wherein the information processing module further includes a linear graph recognizing module, which is configured to recognize the linear graph corresponding to the motion status information, and the information processing module outputs a control command according to the recognition result.

9. The joystick controlling system as claimed in claim 1, wherein the joystick input device further includes a light pen module which is disposed on the surface of the movable carrier and is configured to emit an indicator light signal.
